(19) United States
(12) Patent Application Publication
(10) Pub. No.: US 2008/0147804 A1
(43) Pub. Date: Jun. 19, 2008

(54) Response requested message management system

(76) Inventors: Wesley Jerome Gyure, Wake Forest, NC (US); Ryan Alexander Boyles, Wake Forest, NC (US); Adam Marc Hoover, Wake Forest, NC (US); Paul Franklin McMahan, Apex, NC (US)

Correspondence Address: STEVEN E. BACH, ATTORNEY AT LAW, 10 ROBERTS ROAD, NEWTOWN SQUARE, PA, 19073, US

(21) Appl. No.: 11/642,452

(22) Filed: Dec. 19, 2006

(51) Int. Cl. G06F 15/16

(52) U.S. Cl. 709/206

(57) ABSTRACT

A method is provided for managing response requested messages. A user is enabled to mark a message as a response requested message. The response requested message is presented at a user interface. A response message is linked to the response requested message. The response message is presented at a user interface. The user is queried for response satisfaction. The user interface is updated.

### BACKGROUND

In the business environment and in the personal environment, there is an increasing drive to improve efficiency and accuracy while handling an ever-increasing volume of communication and flow of information. One example of this is messaging systems such as e-mail, instant messaging, and text messaging. Specifically, when a message system user needs information from someone else, they typically send a message (such as by e-mail) to another message system user requesting the desired information.

Shortly after sending the requesting message, the user who sent the message will be intently looking for the response to his/her request for information. However, as time passes and additional tasks are performed the user who has sent the request for information may lose track of the messages that he/she sent for which he/she is awaiting a response.

Currently e-mail messaging system users can mark their e-mail messages with a follow-up tag to make sure that they follow up on those messages for which they have requested a response. However, present e-mail systems do not do much to help the system user when responses are actually received. Instead, it is up to the system user, who tagged the message to correlate the response to the request, take the information request off of his/her to-do list and remove the tag from the message or delete the tagged message from his/her e-mail file.

Moreover, present e-mail systems do not manage messages that request a response. Nor do present systems evaluate messages against a message policy and perform policy actions when the policy is violated.

### SUMMARY

The invention provides a method, program product, and system for managing messages for which a response has been requested (i.e., response requested messages). In an exemplary embodiment of the invention, a method for managing response requested messages enables a user to mark a message as a response requested message. The response requested message is presented at a user interface. A response message is linked to the response requested message, and presented at a user interface. The user is queried for response satisfaction. The user interface is updated to reflect the status of the response requested message.

### BRIEF DESCRIPTION OF THE DRAWINGS

The features and advantages of the invention will be more clearly understood from the following detailed description of the preferred embodiments when read in connection with the accompanying drawing. Included in the drawing are the following figures:

FIG. 1 is a block diagram of a network used for sending and receiving electronic messages according to an exemplary embodiment of the present invention;

FIG. 2 shows a flow diagram of a system for managing response request messages according to an exemplary embodiment of the present invention;

FIG. 3 shows a user interface presentation for addressing a message using a system for managing response request messages according to an exemplary embodiment of the present invention;

FIG. 4 shows another user interface presentation for identifying the entity from which a response is requested using a system for managing response request messages according to an exemplary embodiment of the present invention;

FIG. 5 shows another user interface presentation for presenting received messages for which a response is requested using a system for managing response request messages according to an exemplary embodiment of the present invention;

FIG. 6 shows another user interface presentation for presenting sent messages for which a response is requested using a system for managing response request messages according to an exemplary embodiment of the present invention;

FIG. 7 shows another user interface presentation for presenting a thread of messages for which a response is requested using a system for managing response request messages according to an exemplary embodiment of the present invention; and

FIG. 8 shows another user interface presentation for evaluating a response using a system for managing response request messages according to an exemplary embodiment of the present invention.

### DETAILED DESCRIPTION

The invention provides a system for managing messages for which a response has been requested (i.e., response requested messages). In an exemplary embodiment, a message for which a response is desired is marked or tagged as RESPONSE REQUESTED. Potential responses to the RESPONSE REQUESTED message are associated with it by the system. The system behavior is based on threading technology. Threading technology correlates related messages into a single thread (i.e., an original sent or received message, sent and received responses to the original message, sent and received responses to the responses, etc.). For example a thread of e-mail messages are grouped together, including all sent and received e-mail replies (children) responding to a particular thread (parent). The focus of current threading technology is to group response messages with the sent message to which they respond. It should be understood, however, that not all messages that are sent are meant to create a thread for which a response is awaited. Thus, in this exemplary embodiment, only messages marked as RESPONSE REQUESTED are managed by the system.

When a response is received to a RESPONSE REQUESTED message, the response is associated with the previously sent RESPONSE REQUESTED message using threading technology. Threading technology can operate in a variety of ways. For example, a new message (which is not a reply to a previous message—i.e., parent message) is assigned a global unique identifier (GUID) in the header block of the message. When a reply is created to the original message, such as by using a reply or forward function in e-mail, the GUID of the parent message is applied to the header block of the reply message, which is a child of the original message. Thus, a string of messages or a conversation can be threaded or grouped together using the common GUID. Alternatively, threading may be accomplished by associating messages using user and/or thread information or by filtering messages using common context and characteristics of the messages.

The response message and the RESPONSE REQUESTED message are then presented to the system user for evaluation of the response. If the user indicates that the response is satisfactory the RESPONSE REQUESTED tag is removed and the user interface is updated for this change in status.

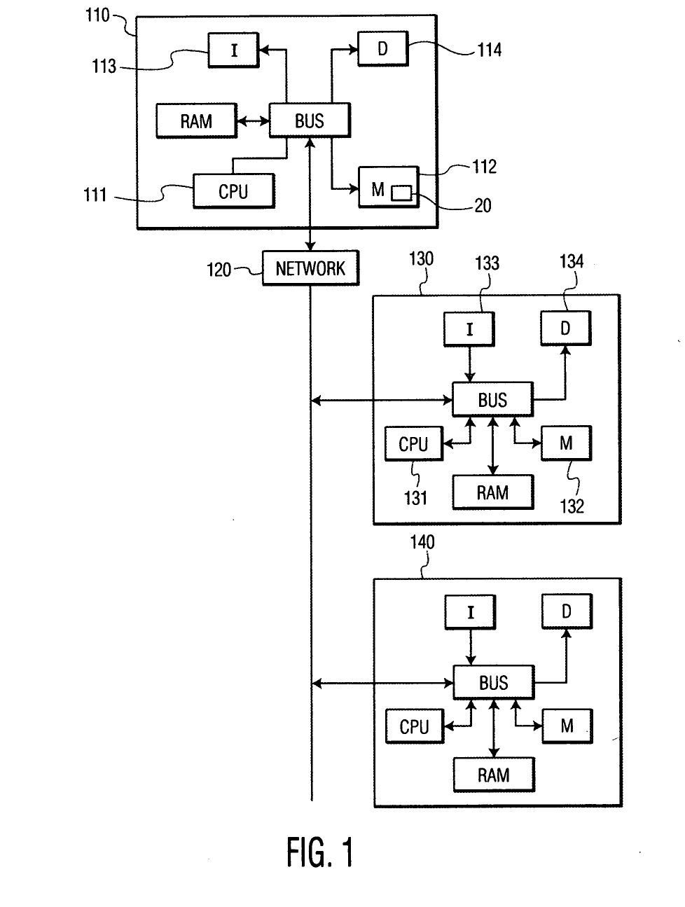

FIG. 1 is a block diagram of a network used for sending and receiving electronic messages according to an exemplary embodiment of the present invention. While the following description is directed to an e-mail messaging system, it will be understood by those skilled in the art that the invention can also be embodied in a text messaging environment, an instant messaging environment, or other messaging environments. An e-mail client 110, in this example a personal computer (PC) comprises a data bus connected to a network 120. Internally, the bus is connected to a processing unit 111, a memory unit 112, an input device 113 and a display or user interface 114.

The client device 110 is enabled for sending and receiving messages through the network, 120, such through an e-mail client program that is stored in memory 112 and loaded in whole or in part into RAM to be executed by the processing unit 111. The processing unit 111 also executes reply requested program code 20 stored in the memory unit (and loaded as necessary into RAM) and allows a user to mark a message as a response requested message through the input device 113. When a response message is received, the response requested program 20 is executed by the processing unit 111 linking the response message to the response requested message and querying the user for response satisfaction at the user interface 114. The processing unit 111 also updates message data in the memory unit 112 and displays message data at the user interface 114.

It should be understood that the response requested program 20 is stored in memory 112 and may be integral with an e-mail client application or the like. Moreover, the response requested message is transferred in whole or in part into RAM (not numbered) during operation. Also, the memory 112 in the illustrated example may be resident on the client device 1 10 and may take the form of an internal or external drive. Alternatively, the memory may be external the client device 110.

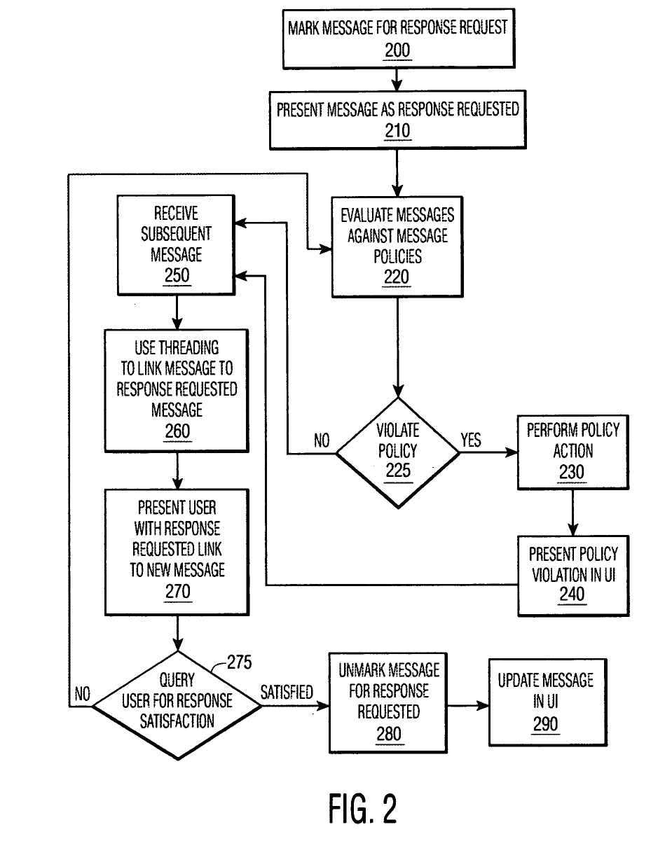

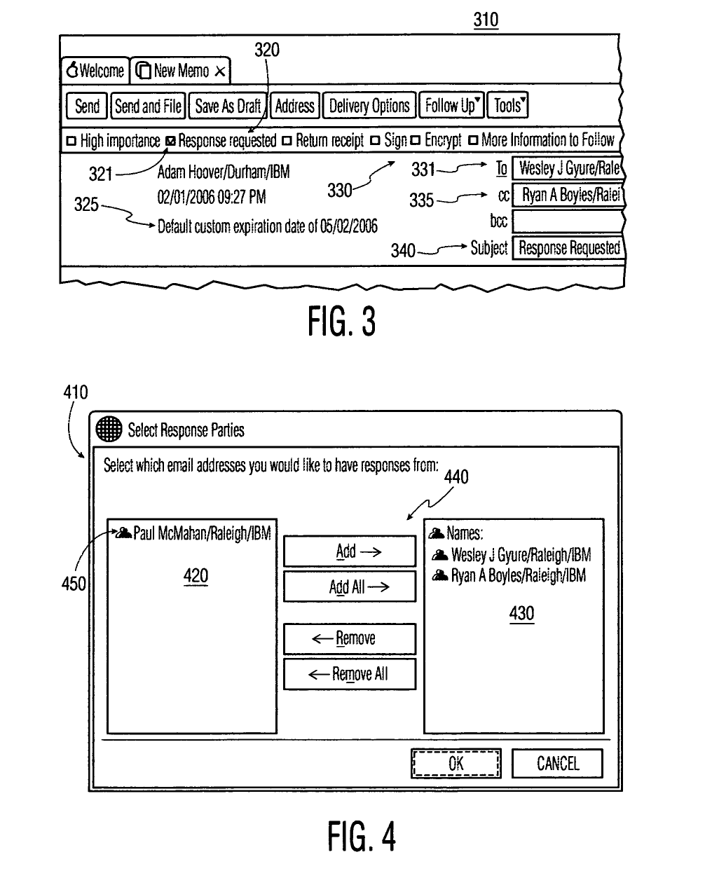

FIG. 2 is a flow diagram of a system for managing RESPONSE REQUESTED messages according to an exemplary embodiment of the invention. During the creation, sending, or review of a message, a system user may decide that a response to the message is desired and that this response should be managed. In this case, as shown in step 200, the system user through the user interface 114 causes the response requested program 20 marks the message being sent as RESPONSE REQUESTED. This may be done in a variety of ways as will be described in detail later with respect to FIGS. 3 and 4. The marked or tagged message is recognizable by the communication system (i.e., any communication client running response requested program 20) as having a RESPONSE REQUESTED status.

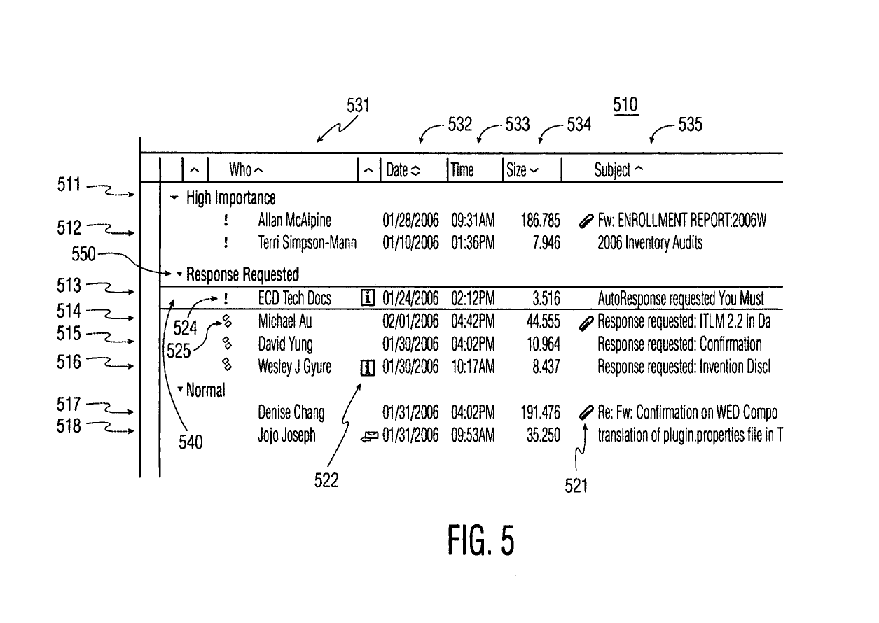

In an exemplary embodiment of the invention, the message is presented to a second system user at a user interface presentation as RESPONSE REQUESTED (step 210). The second user in this example is the system user from whom a response is requested. In an exemplary case the particular user interface presentation is the message recipient's e-mail inbox. This presentation may be embodied in a variety of ways, as will be discussed with reference to FIG. 5. Thus, each system user can readily identify those messages for which a response has been requested from that user, enhancing the user's ability to manage their workflow by providing a visual reminder of a request for response. In this particular embodiment, the response requested message is a request for information to which the system user is expected to respond. Moreover, the sender of the message may also have the message presented as RESPONSE REQUESTED in a user interface presentation. Alternatively, the interface presentation may be a REPONSE REQUESTED message index, listing all sent and received RESONSE REQUESTED messages with their respective threads.

The recipient of the RESPONSE REQUESTED message, in the normal course of events, replies to the RESPONSE REQUESTED message, providing a response message, containing a response such as requested information. The system user who marked the RESPONSE REQUESTED message receives this subsequent message (step 250), which may or may not satisfy the previously requested response.

Using threading technology, the subsequent message is linked to the RESPONSE REQUESTED message (step 260), if it is in the same thread (e.g., has a common GUID, matches user or thread information, meets filtering criteria, or the like). Thus, the response requested program 20 automatically associates potential responses to the RESPONSE REQUESTED message with the RESPONSE REQUESTED message.

The response requested program 20 presents the associated response message and RESPOSE REQUESTED messages to the system user who marked the RESPONSE REQUESTED message (step 270). This presentation is performed at a user interface using one of a variety of interface presentations. For example, the response message and the RESPONSE REQUESTED message may be presented together in a single e-mail presentation showing each e-mail thread in which the system user has been a sender or a recipient. Alternatively, the response message may be presented in an inbox interface presentation with a RESPONSE REQUESTED tag. Then, by selecting the response message, such as by highlighting it, an interface presentation showing the thread to which the response message belongs can be presented.

When the system user opens the response message, the response requested program 20 queries the system user whether or not the response satisfies the RESPONSE REQUESTED message (step 275). The response requested program 20 may perform this step in a user interface presentation by presenting a checkbox for selection, by providing a dialog box for the system user to open, or any other method for enabling a system user to indicate a choice at a user interface.

If the system user determines that the response message satisfies the RESPONSE REQUESTED message, he/she selects the appropriate checkbox or indicates satisfaction through the dialog box or other method. The response requested program 20 then unmarks the satisfied RESPONSE REQUESTED message (step 280) and updates the message status at the user interface (step 290).

If the system user determines that the response message does not satisfy the RESPONSE REQUESTED message, he/she does not select the appropriate checkbox or otherwise indicate satisfaction. Thus, a RESPONSE REQUESTED message that has not been satisfied continues to be marked as RESPONSE REQUESTED at the user interface.

In an exemplary embodiment of the invention, a message that is marked as RESPONSE REQUESTED (step 200) is evaluated against message policies (step 220). This step can be performed, for example, by an operation or code sequence in the response requested program 20 that automatically runs at periodic intervals. An exemplary message policy that RESPONSE REQUESTED messages are evaluated against is notification of response date or time. The response date or response time may be a default value programmed into the policy or may be selected by the system user who sets the RESPONSE REQUESTED status. The policy defines the action that is taken when the policy is violated. Essentially, the policy defines a time limit for an action and the response taken for violating the time limit.

The response requested program 20 determines whether or not the RESPONSE REQUESTED message violates the message policy (step 225). If the RESPONSE REQUESTED message violates the message policy, then the response requested program 20 initiates a policy action (step 230) and presents the policy violation at a user interface (step 240). The response requested program 20 continues to receive and evaluate response messages and to evaluate the message policy. If the RESPONSE REQUESTED message does not violate the message policy, then the response requested program 20 continues to receive and evaluate response messages and to evaluate the RESPONSE REQUESTED message for violations of the message policy.

In the example where the message policy is a response date or time, the response requested program 20 compares the requested date or time for a response to the RESPONSE REQUESTED message to the actual date or time. If the requested date or time is later than the actual date or time the policy is not violated. If the requested date or time is earlier than the actual date or time the policy is violated.

In an example where the policy is a requested response date or time, the policy action upon violation of the policy is to change the status of the RESPONSE REQUESTED message to PAST DUE RESPONSE REQUESTED message. A further violation action may be, for example, a message to the entity from which the response is requested, reminding that entity of the RESPONSE REQUESTED message and the expiration of the date or time of the request. Another further policy action might be a reminder note to the entity that marked the RESPONSE REQUESTED message.

When a policy violation occurs, the response requested program 20 presents the policy violation at a user interface (step 240). In the forgoing example, the policy violation may be presented, for example, by highlighting the past due RESPONSE REQUESTED message in a requestor's user interface presentation and/or a user interface presentation of the entity from whom the response is requested. Alternatively, another form of communication may be driven (e.g., sending a page to a pager, placing a pre-defined phone call, contacting the receiver's manager via a note, etc.)

Another example of a message policy is a time limit for sending any e-mail message. One might assume that if a person has not sent any e-mail messages for a period of time, then they are probably out of the office. The response requested program 20 could be cognizant of the fact that a person has not sent any e-mail correspondence in a prescribed period of time, which would indicate an absence, and the policy could have a defined escalation path for such an occurrence.

FIG. 3 shows a user interface presentation for addressing a message using a system for managing response request messages according to an exemplary embodiment of the present invention. In a communication client interface (here an e-mail client application at a personal computer or work station), a system user enters a user interface presentation 210 appropriate for sending a message. The user interface presentation 310 may be configured in a wide variety of ways provided that it has an addressing feature 330 and a RESPONSE REQUESTED option 320. The addressing feature enables the system user to provide or select entities 331 to receive the message, and typically also entities 335 to receive a copy of the message.

The RESPONSE REQUESTED option 320, allows the system user to mark a message as RESONSE REQUESTED. In the illustrated example, the RESPONSE REQUESTED option 320 is a checkbox 321 provided on a tool bar in the e-mail system user interface. It should be understood, however, that the RESPONSE REQUESTED option might be realized in a variety of ways. For example, it could be provided in a dialog box that can be opened from the addressing presentation or another user interface presentation. Alternatively, the system user sending the RESPONSE REQUESTED message might right click a name in any of the addressing fields, and select from a pop-up box the choice of response requested.

In the illustrated exemplary embodiment, a system user has selected the RESPONSE REQUESTED checkbox 321. As shown, selecting the RESPONSE REQUESTED checkbox 321 has caused the response requested program 20 to include the words Response Requested in the subject 340 of the message in the illustrated embodiment. In this embodiment, selecting the RESPONSE REQUESTED checkbox 321 also causes the response requested program 30 to display an expiration date/time 325 and to open a RESPONSE REQUESTED user interface presentation 410 (shown in FIG. 4).

The expiration date/time 325 may be a default generated by the response requested program 20 or selected by the system user based on when the RESPONSE REQUESTED status is invoked. In an exemplary embodiment, the default expiration date/time 325 may be modified to create a custom expiration date/time by which the response is requested.

The system user marking a message as RESPONSE REQUESTED may select another system user from whom he/she would like a response. This may be accomplished in various ways. For example, the response requested program 20 might enable the system user to select one or more addresses from the addressing interface presentation 310, such as by highlighting and selecting addresses. Alternatively, the response requested program 20 may automatically open a separate RESPONSE REQUESTED presentation 410 as shown in FIG. 4. In each case, the system user will select one or more addresses or users from whom a response is expected.

FIG. 4 shows a user interface presentation 410 for identifying the entity from whom a response is requested using a response requested program 20 for managing response request messages according to an exemplary embodiment of the present invention. In the illustrated embodiment, the response requested program, through the RESPONSE REQUESTED user interface presentation 410, queries the system user which email addresses the user would like to have a response from. The selected email addresses 420 are displayed in one area of the RESPONSE REQUESTED user interface presentation 410, and the addresses of the addressees 430 of the message are displayed in another area of the RESPONSE REQUESTED user interface presentation 410. Addresses may be selected by dragging the addresses of one or more addressees 430 into the area for selected addresses 420. Alternatively, one or more addressee addresses 430 may be highlighted and an add option 440 may be used to add those addresses to the selected addresses 420.

FIG. 5 shows another user interface presentation for presenting messages for which a response is requested using a response requested program 20 for managing response request messages according to an exemplary embodiment of the present invention. In the illustrated embodiment, message headers 511-518 for received messages are presented on a message index user interface presentation 510. Each message header in the illustrated example includes: a sender identifier 531 such as a person's name, a date sent 532, a time sent 533, a file size 534, and a subject 535. The contents of the message headers may vary from system to system without affecting the scope of the invention. As shown, the headers may further include icons, such as an attachment icon 521 and information to follow icon 522. A RESONSE REQUESTED icon 525 is displayed in the illustrated example on regular RESONSE REQUESTED messages to indicate their status, and an urgent RESPONSE REQUESTED icon 524 is displayed on urgent RESONSE REQUESTED messages to indicate their status.

As shown in FIG. 5, a message header 513 for a past due RESPONSE REQUESTED message may be presented in a manner that identified its past due status. This may be accomplished, for example by highlighting the header 513 for the past due RESPONSE REQUESTED message in a contrasting color.

To enhance efficiency, headers 513-516 for received RESPONSE REQUESTED messages may be segregated from message headers for other received messages under a RESPONSE REQUESTED heading 550. Moreover, the headers 513-516 for RESPONSE REQUESTED messages may be displayed before the headers for normal messages. Thus, a system user may easily be provided with a visual reminder of messages for which a response is requested, enhancing a system user's ability to identify, manage, and satisfy requests for responses using a messaging system.

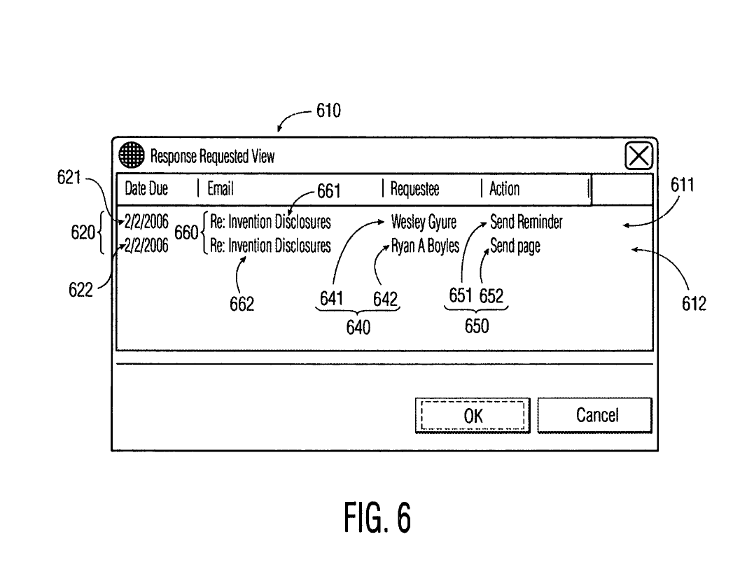

FIG. 6 shows a user interface presentation 610 for showing sent RESPONSE REQUESTED messages. The sent RESPONSE REQUESED user interface presentation may be, for example, an index presentation showing a listing of headers for sent RESPONSE REQUESTED messages, as illustrate. Alternatively, the sent RESPONSE REQUESTED user interface may be configured in a variety of other ways that allow a system user to view a listing of messages sent as RESPONSE REQUESTED messages. For example, an alternative RESPONSE REQUESTED user interface presentation might provide RESPONSE REQUESTED threads.

In the exemplary embodiment illustrated in FIG. 6, RESPONSE REQUESTED message listings 61J, 612 are displayed with certain useful information about those RESPONSE REQUESTED messages. For example, the status or most recent action 650 may be provided for each message sent as a RESPONSE REQUESTED message. Also, the due date or date that a response is requested 620, the requestee 640, and the message header 660 may also be displayed, as may other useful information about the RESPONSE REQUESTED messages. In the illustrated example two RESPONSE REQUESTED message listings 611, 612 are shown. The first RESPONSE REQUESTED message 611 has requested a response of a first requestee 641 (Wesley Gyure). This first Response REQUESTED message 611 was requested by a first due date 621 (Feb. 2, 2006), and has a first message header 661 (RE: Invention Disclosure). This first Response REQUESTED message 611 has a first status 651 (send reminder—meaning that the message has been sent and the next action would be to send a reminder, which would typically be a policy action). The second RESPONSE REQUESTED message 612 has requested a response of a second requestee 642 (Ryan A Boyles). This second Response REQUESTED message 612 was requested by a second due date 622 (Feb. 2, 2006), and has a second message header 662 (RE: Invention Disclosure). This second Response REQUESTED message 612 has a second status 652 (send page—meaning that the page has not yet been sent)

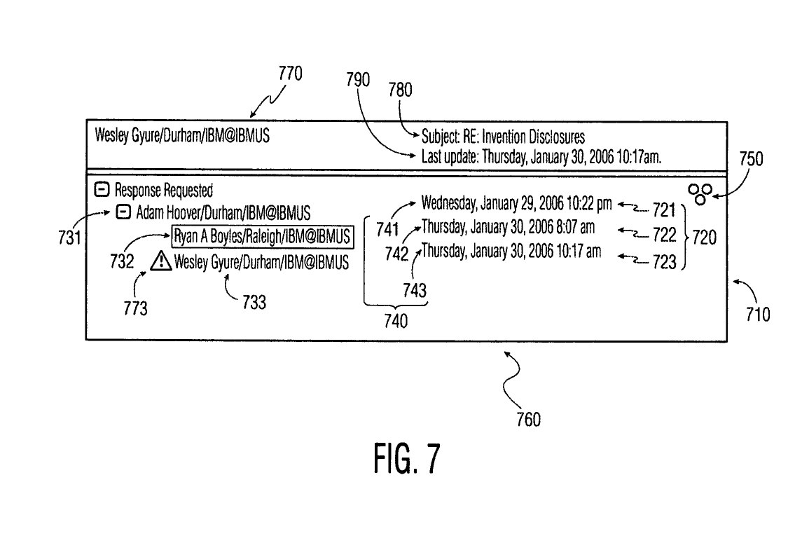

In an exemplary embodiment, the headers for all messages in a particular thread may be displayed in a message thread user interface presentation 710, as illustrated in FIG. 7. This message thread user interface presentation 710 may be displayed, for example, by hovering over a header for a RESPONSE REQUESTED message or selecting a RESPONSE REQUESTED message from one of the RESPONSE REQUESTED message listings 510, 610.

In an exemplary embodiment, as shown in FIG. 7, a message thread user interface presentation 710 displays headers 720 for each message in a thread. The original message 721 is listed first, with responses to the original message 722, 723 listed below the original message 721 and indented from the original message 721.

For each message 721, 722, 723, the author of the message 731, 732, 733 respectively is displayed, and the date and time when each message was sent 741, 742, 743 respectively are displayed. The sender 770 of the current message and the subject 780 and last update 790 for the thread are also displayed.

In the illustrated example, the first response 722 is highlighted. The response text for the highlighted message, in this example the first response text 760 is also presented in the thread user interface presentation 710. An icon 773 adjacent to a message author indicates that the message is from the entity from which a response is requested (in this case the third author 733). Thus, a system user can view a listing of the messages 721, 722, 723 in a message thread, identify messages from the response requestee, and view the text 770 for one of these messages all in a single user interface presentation 710.

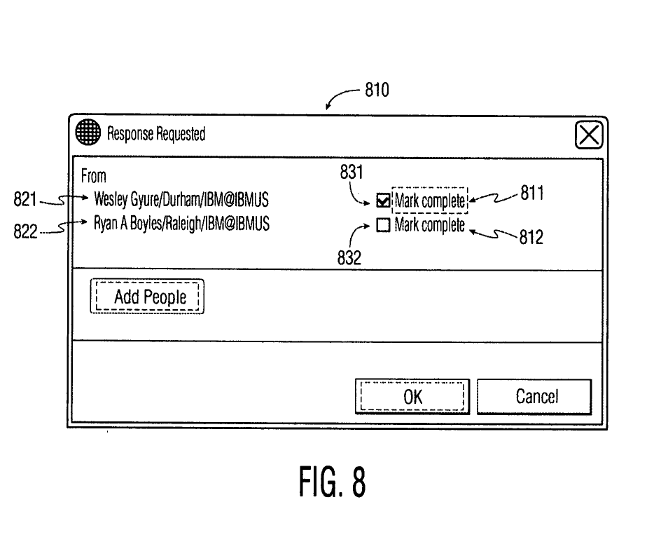

To enhance the effectiveness of the response requested program 20, the response requested program 20 presents an evaluation icon 750 in the message thread user interface presentation 710 in an exemplary embodiment of the invention. By selecting the evaluation icon 750, a system user is presented with an evaluation user interface presentation 810, as shown in FIG. 8. Alternative methods for evaluating a response to a RESPONSE REQUESTED message are possible within the scope of the invention. For example, a checkbox could be provided in the message thread user interface presentation 710, or a dialog box could display automatically when a response is received from an entity from whom a response is requested.

FIG. 8 shows another user interface presentation 810 for evaluating a response using a response requested program 20 for managing response request messages according to an exemplary embodiment of the present invention. As shown in FIG. 8, each response 811, 812 in a RESPONSE REQUESTED message thread is presented in the response evaluation user interface presentation 810. The response requested program 20, through the response evaluation user interface presentation 810, queries the system user whether or not the response satisfies the RESPONSE REQUESTED message. In the illustrated example, each response message 811, 812 is listed with the author of the response message 821, 822. Check boxes 831, 832 are provided to indicate a satisfactory answer. In this example the checkboxes are labeled “Mark complete”, however any label that indicates the purpose of the checkbox may be used. Alternatively, other methods of indicating that a response is satisfactory or that the response request is complete may be used.

Although illustrated and described above with reference to certain specific embodiments, the present invention is nevertheless not intended to be limited to the details shown. Rather, various modifications may be made in details within the scope and range of equivalents of the claims and without departing from the spirit of the invention. For example the term RESPONSE REQUESTED is used for ease of description, however any other term or symbol may be used in the various user interface presentations to indicate a status where a response is expected. Also, the response requested program 20 could be more basic in the sense of whether there was a response (meaning any response) to a RESPONSE REQUESTED message, or there was no response. For example, one might want the opposite of a response requested, meaning he/she only wants a response if the recipient no longer needs access to a particular database, and if no response is received the lack of a response will be considered as an affirmative answer.

What is claimed is:

1. A method for managing response requested messages, said method comprising the steps of:
enabling a user to mark a message as a response requested message;
presenting the response requested message at a user interface;
linking a response message to the response requested message;
presenting the response message at a user interface;
querying the user for response satisfaction; and
updating the user interface.

2. The method of claim 1 wherein the user is a sender of the message.

3. The method of claim 1 wherein the user is a recipient of the message.

4. The method of claim 1 wherein the user is a copy recipient of the message.

5. The method of claim 1, wherein the response requested message is presented at a user interface as a message header.

6. The method of claim 1, wherein the response message is linked to the response requested message using threading.

7. The method of claim 1, further comprising the steps of:
evaluating the response requested message against a message policy;
determining whether the response requested message violates the message policy; and
performing a policy action when the response requested message violates the policy.

8. The method of claim 7, further comprising the step of:
presenting the message policy violation at a user interface.

9. The method of claim 7, wherein the step of performing a policy action when the response requested message violates the policy comprises automatically resending the response requested message.

10. The method of claim 7, wherein the step of performing a policy action when the response requested message violates the policy comprises automatically sending a notice of the policy violation.

11. The method of claim 8, wherein the message policy violation is presented at a user interface to the system user who marked the message as response requested.

12. The method of claim 8, wherein the message policy violation is presented at a user interface to another system user who received the response requested message.

13. The method of claim 8, wherein the message policy violation is presented at a user interface as a highlighted message header.

14. A program product comprising a machine usable medium having machine usable program code for managing response requested messages, said program product comprising:
machine usable program code for enabling a user to mark a message to form a response requested message;
machine usable program code for presenting the response requested message at a user interface;
machine usable program code for linking a response message to the response requested message;
machine usable program code for presenting the response message at a user interface;
machine usable program code for querying the user for response satisfaction; and
machine usable program code for updating the user interface.

15. The program product of claim 14 wherein the machine usable program code for presenting the response requested message at a user interface comprises machine usable program code for presenting a header for the response requested message.

16. The program product of claim 14, further comprising:
machine usable program code for evaluating the response requested message against a message policy;
machine usable program code for determining whether the response requested message violates the message policy; and
machine usable program code for performing a policy action when the response requested message violates the policy.

17. The program product of claim 17, further comprising:
machine usable program code for presenting the message policy violation at a user interface.

18. A system for managing response requested messages, comprising a client device enabled for sending and receiving messages through a network, said client device having:
a processing unit for executing code to manage sent and received messages;
an input device enabling a user to mark a message as a response requested message;
a user interface for presenting the response requested message; and
a data storage drive for storing executable code and message data;
wherein said processing unit executing code from said data storage drive: allows a user to mark a message as a response requested message through said input device; links a response message to said response requested message; queries the user for response satisfaction at said user interface; updates message data in said data storage drive; and displays message data at said user interface.

19. The system of claim 18, wherein said client device is a computer connected to the internet.

20. The system of claim 18, wherein said client device is a mobile phone connected to a wireless network.
